(19) United States
(12) Patent Application Publication
(10) Pub. No.: US 2026/0131784 A1
(43) Pub. Date: May 14, 2026

(54) LANE DEPARTURE WARNING DEVICE, LANE DEPARTURE WARNING METHOD AND PROGRAM

(71) Applicant: TOYOTA JIDOSHA KABUSHIKI KAISHA, Aichi (JP)

(72) Inventor: Keito INOUE, Toyota-shi (JP)

(21) Appl. No.: 19/354,848

(22) Filed: Oct. 10, 2025

(30) Foreign Application Priority Data
Nov. 11, 2024 (JP) 2024-196747

(51) Int. Cl. B60W 30/12; B60W 30/095; B60W 50/14

(52) U.S. Cl. CPC B60W 30/12; B60W 30/0956; B60W 50/14; B60W 2050/143; B60W 2510/202

(57) ABSTRACT

To suppress the occurrence of two types of lane departure warnings, provided is a lane departure warning device that executes a warning when a vehicle departs from a lane in which the vehicle is traveling, comprising: an LTA control unit configured to determines whether the vehicle is likely to depart from the lane during execution of lane keeping control, and when determines that lane departure is likely, executes a first lane departure warning; an LDA control unit configured to determines whether the vehicle is likely to depart from the lane while the vehicle is traveling, and when determines that lane departure is likely, performs a steering control to suppress the lane departure of the vehicle and executes a second lane departure warning; and an LDA priority processing unit configured to prioritizes the steering control and the second lane departure warning over the first departure warning.

### CROSS-REFERENCE TO RELATED APPLICATION

This application claims priority to Japanese Patent Application No. JP2024-196747 filed on Nov. 11, 2024, the content of which is hereby incorporated by reference in its entirety into this application.

### BACKGROUND OF THE INVENTION

### 1. Field of the Invention

The present disclosure relates to a lane departure warning device, a lane departure warning method and a program.

### 2. Description of the Related Art

As a type of driving assistance control for a vehicle, lane departure suppression control (Lane Departure Alert Control, hereinafter referred to as “LDA control”) is known, which suppresses the vehicle from deviating from the traveling lane. For example, Japanese Patent Application Laid-Open (kokai) No. 2023-082251 discloses a technique in which LDA control is executed earlier when it is determined that the driver has released the steering wheel, compared to when it is determined that the driver has not released the steering wheel.

In addition to the aforementioned LDA control, driving assistance control for a vehicle also includes lane trace assist control (LTA control), which keeps the vehicle within the traveling lane. Both the LDA control and the LTA control execute a lane departure warning when the vehicle departs or is about to depart from the traveling lane. Therefore, when the lane departure warnings of the LDA control and the LTA control operate in parallel, both types of warnings may be issued consecutively, which presents a problem in that the driver may find such warnings bothersome.

### SUMMARY OF THE INVENTION

The present disclosure has been made in order to solve the above-described problem, and an object thereof is to effectively suppress the consecutive occurrence of two types of lane departure warnings.

A device according to at least one embodiment of the present disclosure is a lane departure warning device configured to execute a warning when a vehicle departs or is likely to depart from a traveling lane during driving, comprising:
a first alert unit that, during execution of a lane keeping control to keep the vehicle within the lane, determines whether the vehicle is likely to depart from the lane, and if it is determined that lane departure is likely, executes a first departure warning;
a second alert unit that, during travel of the vehicle, determines whether the vehicle is likely to depart from the lane, and if it is determined that lane departure is likely, performs a steering control to suppress the lane departure of the vehicle and executes a second departure warning; and
a priority processing unit that, during execution of the lane keeping control, prioritizes at least one of the steering control or the second departure warning by the second alert unit over the execution of the first departure warning by the first alert unit.

### BRIEF DESCRIPTION OF THE DRAWINGS

FIG. 1 is a schematic diagram showing the hardware configuration of a vehicle according to the present embodiment.

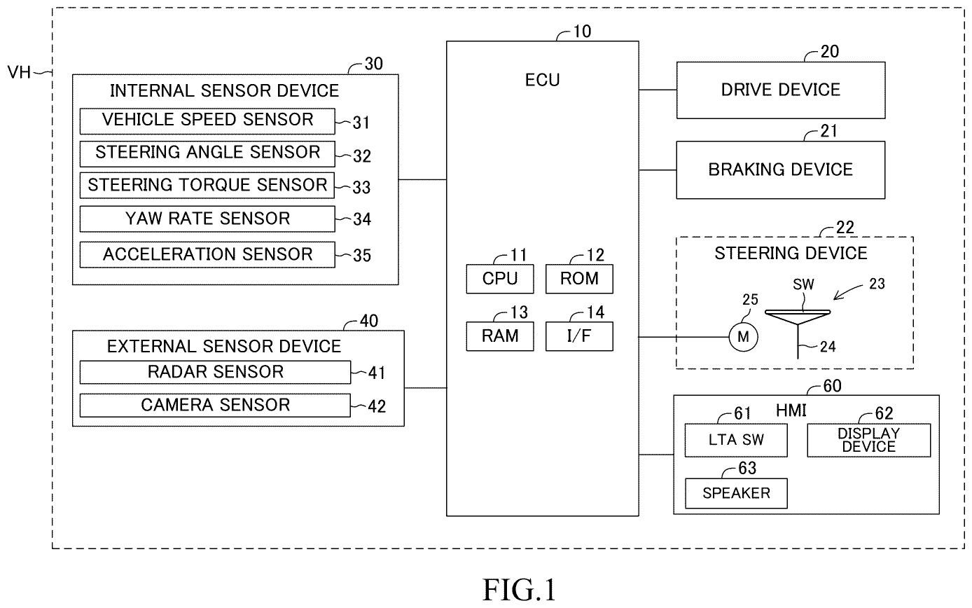

FIG. 2 is a schematic diagram showing the software configuration of a control device according to the present embodiment.

FIG. 3 is a schematic diagram illustrating the LDA control.

FIG. 4 is a schematic diagram illustrating the LDA priority processing according to the present embodiment.

FIG. 5 is a schematic diagram illustrating a conventional example.

FIG. 6 is a flowchart illustrating a routine of the LDA priority processing according to the present embodiment.

### DESCRIPTION OF THE EMBODIMENTS

Hereinafter, a lane departure warning device, a lane departure warning method, and a program according to the present embodiment will be described with reference to the drawings.

### [Hardware Configuration]

FIG. is a schematic diagram showing the hardware configuration of a vehicle VH according to the present embodiment.

The vehicle VH includes an ECU (Electronic Control Unit) 10. The ECU 10 includes a CPU (Central Processing Unit) 11, a ROM (Read Only Memory) 12, a RAM (Random Access Memory) 13, and an interface device 14, among others. The CPU 11 is a processor that executes various programs stored in the ROM 12. The ROM 12 is a non-volatile memory that stores data and the like necessary for the CPU 11 to execute various programs. The RAM 13 is a volatile memory that provides a work area for use when the various programs are executed by the CPU 11. The interface device 14 is a communication device for communicating with external devices.

The ECU 10 serves as a central device for performing driving assistance such as LDA control and LTA control. Driving assistance is a concept that includes autonomous driving. The ECU 10 is communicably connected to a drive device 20, a braking device 21, a steering device 22, an internal sensor device 30, an external sensor device 40, an HMI (Human Machine Interface) 60, and the like.

The drive device 20 generates a driving force that is transmitted to the drive wheels of the vehicle VH. Examples of the drive device 20 include an electric motor and an engine. The braking device 21 applies a braking force to the wheels of the vehicle VH.

The steering device 22 applies a steering force to the wheels of the vehicle VH. The steering device 22 may be of a rack-and-pinion type or a steer-by-wire type. The steering device 22 includes a steering operation unit 23 such as a steering wheel SW. The steering device 22 also includes a steering motor 25 that applies steering torque to a steering shaft 24. The steering motor 25 generates steering torque in response to a command from the ECU 10. This steering torque allows the left and right steerable wheels of the vehicle VH to be turned. Note that the steering operation unit 23 is not limited to the steering wheel SW, and may have a form other than a wheel, such as a steering bar.

The internal sensor device 30 includes various sensors for detecting the state of the vehicle VH. Specifically, the internal sensor device 30 includes a vehicle speed sensor 31, a steering angle sensor 32, a steering torque sensor 33, a yaw rate sensor 34, an acceleration sensor 35, and the like.

The vehicle speed sensor 31 detects a traveling speed (vehicle speed V) of the vehicle VH. The steering angle sensor 32 detects a rotational angle of the steering wheel SW or the steering shaft 24, that is, a steering angle σD. The steering torque sensor 33 detects a rotational torque of the steering wheel SW or the steering shaft 24, that is, a steering torque Tq. The yaw rate sensor 34 detects a yaw rate of the vehicle VH. The acceleration sensor 35 detects an acceleration of the vehicle VH. The internal environment sensor device 30 transmits the state of the vehicle VH detected by the sensors 31 to 35 to the ECU 10 at a predetermined cycle.

The external sensor device 40 includes various sensors for recognizing object information regarding objects around the vehicle VH. Specifically, the external sensor device 40 includes a radar sensor 41, a camera sensor 42, and the like. Examples of the object information include surrounding vehicles, lane markings such as white lines drawn on the road surface, curbs, guardrails, and walls.

The radar sensor 41 detects objects present around the vehicle VH. The radar sensor 41 includes a millimeter-wave radar and/or a LiDAR. The millimeter-wave radar emits radio waves in the millimeter-wave band (millimeter waves) and receives millimeter waves (reflected waves) reflected by objects present within the radiation range. Based on the phase difference between the transmitted and received waves, the attenuation level of the reflected wave, the time elapsed from transmission of the millimeter wave to reception of the reflected wave, and the like, the millimeter-wave radar acquires the relative distance and relative speed between the vehicle VH and the object. The LiDAR sequentially scans pulsed laser light, which has a shorter wavelength than millimeter waves, in multiple directions, and receives reflected light that is reflected by objects. The LiDAR thereby acquires the shape of objects detected in front of the vehicle VH, the relative distance between the vehicle VH and the object, the relative speed, and the like.

The camera sensor 42 captures images of the surroundings of the vehicle VH and acquires object information regarding the surroundings of the vehicle VH by processing the captured image data. As the camera sensor 42, a digital camera having an imaging element such as a CMOS or CCD may be used. The object information represents, for example, the type of object detected around the vehicle VH, the relative distance between the vehicle VH and the object, the relative speed, and the like. The type of object may be recognized, for example, by machine learning such as pattern matching.

The external sensor device 40 repeatedly transmits the acquired object information to the ECU 10 at predetermined time intervals. The ECU 10 determines the relative relationship between the vehicle VH and an object by integrating the relative relationship obtained by the radar sensor 41 and the relative relationship obtained by the camera sensor 42. Note that the external sensor device 40 does not necessarily need to include both the radar sensor 41 and the camera sensor 42, and may include, for example, only the camera sensor 42.

The HMI 60 is an interface for input and output of information between the ECU 10 and the driver, and includes an input device and an output device. Examples of the input device include an LTA activation switch 61, a touch panel, a voice input microphone, and the like. The LTA activation switch 61 is an ON/OFF switch for the driver to select whether to activate or deactivate the LTA. Examples of the output device include a display device 62, a speaker 63, and the like. The display device 62 may be, for example, a center display installed on an instrument panel, a multi-information display, a head-up display, or a navigation system display. The speaker 63 may be, for example, a speaker of an audio system or a navigation system.

### [Software Configuration]

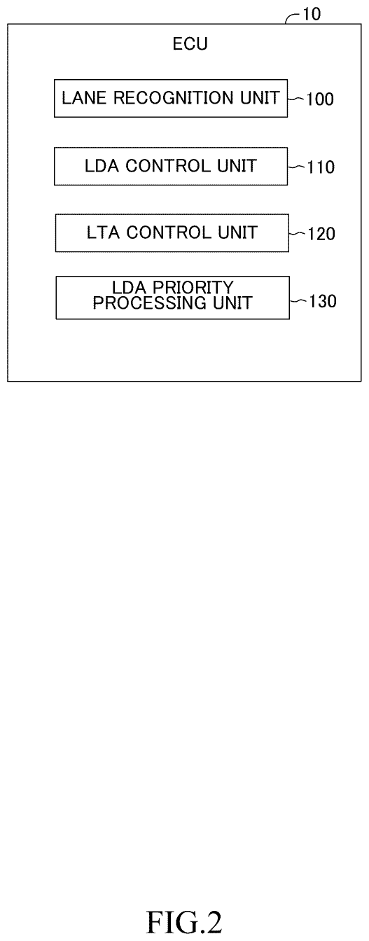

FIG. 2 is a schematic diagram illustrating the software configuration of the ECU 10 according to the present embodiment. As shown in FIG. 2, the ECU 10 includes, as functional elements, a lane recognition unit 100, an LDA control unit 110, an LTA control unit 120, an LDA priority processing unit 130, and the like. Each of the functional elements 100 to 130 is implemented by the CPU 11 of the ECU 10 executing programs stored in the ROM 12 after reading them into the RAM 13. In the present embodiment, these functional elements 100 to 130 are described as being included in the ECU 10, which is a single hardware unit; however, some of them may be provided in another ECU separate from the ECU 10. Further, all or part of the functional elements 100 to 130 of the ECU 10 may be provided in an information processing device of a facility (e.g., a management center) that is capable of communicating with the vehicle VH.

The lane recognition unit 100 recognizes a lane on which the vehicle VH is traveling, based on detection results from the external environment sensor device 40. Here, the term “lane” refers not only to demarcation lines such as white lines or yellow lines drawn on the road surface, but also to travelable areas defined by structures such as curbs, guardrails, and walls. In the following description, for convenience, the boundary of a travelable area defined by such demarcation lines or structures is referred to as a “boundary line”.

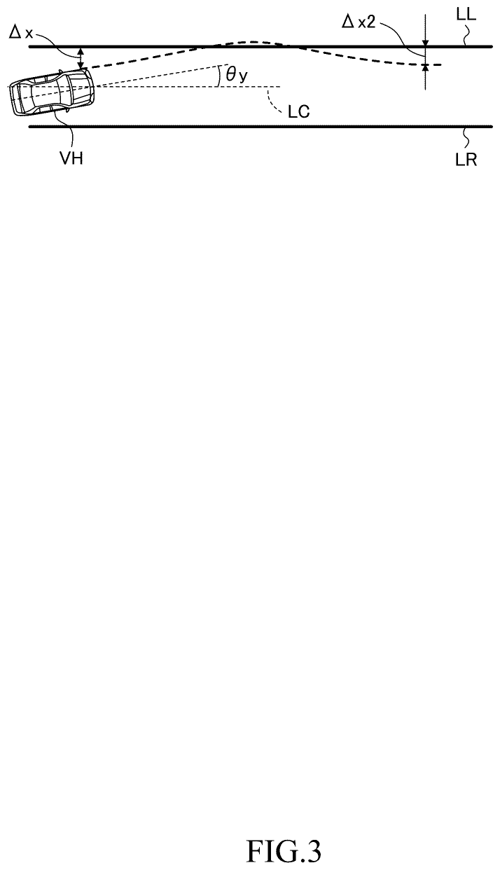

As shown in FIG. 3, the lane recognition unit 100 recognizes a left boundary line LL and a right boundary line LR. The lane recognition unit 100 calculates a curvature radius R of a center line LC that is located at the central position between the left and right boundary lines LL and LR, and also calculates a deviation angle (hereinafter referred to as a yaw angle θy) between the direction of the center line LC and the direction in which the vehicle VH is facing. Furthermore, the lane recognition unit 100 calculates the lateral distance (hereinafter referred to as a lateral position Δx) between the vehicle VH (for example, the left front wheel) and the left boundary line LL, and the lateral distance between the vehicle VH (for example, the right front wheel) and the right boundary line LR. FIG. 3 illustrates only the lateral position Δx between the vehicle VH and the left boundary line LL. In this case, although there are two lateral positions Δx (left and right), in executing the LDA control described later, it is sufficient to use the lateral position Δx in the direction in which the vehicle VH is estimated to depart from the lane, that is, the direction indicated by the yaw angle θy. Hereinafter, the lateral position Δx, yaw angle θy, and curvature radius R calculated by the lane recognition unit 100 are collectively referred to as “lane information”.

The LDA control unit 110 executes LDA control to suppress the vehicle VH from departing from a lane by issuing a warning and controlling the operation of the steering device 22 when the vehicle VH is traveling at a speed equal to or higher than a predetermined threshold vehicle speed Vv and is about to depart from the lane or is likely to depart therefrom. Hereinafter, the warning issued by the LDA control unit 110 is referred to as an “LDA departure warning,” and the steering control executed by the LDA control unit 110 is referred to as “LDA steering control”.

The LDA control unit 110 determines whether the LDA steering initiation condition is satisfied when the vehicle speed V of the vehicle VH becomes equal to or greater than the threshold vehicle speed Vv. As an example of the LDA steering initiation condition, the predicted arrival time TR (or the lateral position Δx of the vehicle VH) until the vehicle VH reaches the boundary line LL or LR (LL in the illustrated example) becomes equal to or less than a predetermined LDA steering threshold value TLDA_1. The predicted arrival time TR can be calculated, for example, based on a well-known formula that assumes the vehicle VH performs uniformly accelerated linear motion until it reaches the boundary lines LL or LR.

The LDA control unit 110, upon the fulfillment of the LDA steering initiation condition, calculates a target steering angle for LDA control (hereinafter referred to as “LDA target steering angle σB”) based on the lane information (Δx, θY, R) acquired by the lane recognition unit 100. The LDA target steering angle σB is a steering angle set such that the vehicle VH does not depart outside the lane boundary lines LL and LR (in the illustrated example, the left boundary line LL). The LDA control unit 110 calculates an LDA assist torque Ts based on the steering angle difference Ao between the LDA target steering angle σB and the actual steering angle σD obtained from the steering angle sensor 32. After calculating the LDA assist torque Ts, the LDA control unit 110 transmits a command signal including information representing the LDA assist torque Ts to the steering device 22. As a result, the LDA assist torque Ts is transmitted from the turning motor 25 to the steering shaft 24, thereby turning the steered wheels of the vehicle VH.

Additionally, when executing the LDA steering control, the LDA control unit 110 determines whether the LDA warning execution condition is satisfied. An example of the LDA warning execution condition is when the predicted time to reach the boundary line LL or LR (i.e., the predicted arrival time TR), or the lateral position Δx of the vehicle VH, becomes equal to or less than a predetermined LDA warning threshold value TLDA_2, which is smaller than the LDA steering threshold value TLDA_1. It should be noted that the LDA warning threshold value TLDA_2 may be the same as the LDA steering threshold value TLDA_1. If the LDA warning execution condition is satisfied, the LDA control unit 110 executes an LDA deviation warning. The LDA deviation warning may be executed, for example, by displaying an alert image on the display device 62, emitting a warning sound from the speaker 63, or applying vibration to the steering wheel SW.

After initiating the LDA control, when the lateral position Δx of the vehicle VH, obtained by the lane recognition unit 100, becomes equal to or greater than a predetermined end determination lateral position Δx2, the LDA control unit 110 determines that the vehicle VH has recovered from lane departure (i.e., the LDA end condition is satisfied), and terminates the LDA control.

The LTA control unit 120 executes LTA (Lane Tracing Assist), which automatically adjusts the steering angle (i.e., the steering angle of the steered wheels) so that, for example, the center of gravity position of the vehicle VH is maintained near a target travel line within the lane. Since LTA itself is well known, a brief explanation will be provided below. When the LTA activation switch 61 is turned ON, the LTA control unit 120 sets a target travel line of the vehicle VH based on the left and right boundary lines LL and LR recognized by the lane recognition unit 100. The target travel line is, for example, set to the center line LC, which lies midway between the left and right boundary lines LL and LR. The LTA control unit 120 controls the operation of the steering device 22 so as to change the steering angle of the vehicle VH in a manner that maintains the center of gravity position of the vehicle VH near the target travel line within the lane. As a result, the vehicle VH is kept within the lane during travel.

The LTA control unit 120 executes an alarm when the vehicle VH deviates from or is about to deviate from the lane during execution of LTA control, due to reasons such as steering intervention by the driver or control limitations caused by traveling on a curved road. Hereinafter, the alarm executed by the LTA control unit 120 is referred to as the “LTA deviation alarm.” The LTA control unit 120 determines whether the LTA alarm execution condition is satisfied during the execution of LTA control. The LTA alarm execution condition may be, for example, when the predicted time to reach the boundary line LL or LR (or the lateral position Δx of the vehicle VH) becomes equal to or less than a predetermined LTA alarm threshold value T_{LTA}. The LTA alarm threshold T_{LTA} is not particularly limited but may be, for example, greater than the aforementioned LDA steering threshold T_{LDA_1} and the LDA alarm threshold T_{LDA_2}. When the LTA alarm execution condition is satisfied, the LTA control unit 120 executes the LTA deviation alarm. The LTA deviation alarm is performed, for example, by sounding a warning tone from the speaker 63 or by displaying a cautionary image (such as a hands-off warning prompting the driver to operate the steering wheel) on the display device 62.

Meanwhile, when the vehicle speed V of the vehicle VH becomes equal to or greater than the threshold speed Vv during execution of the LTA control, the LDA control also becomes enabled. In a conventional device, under such circumstances, when the vehicle VH departs from, or is about to depart from, its own lane while traveling, an LDA departure warning is generated in succession in addition to the LTA departure warning.

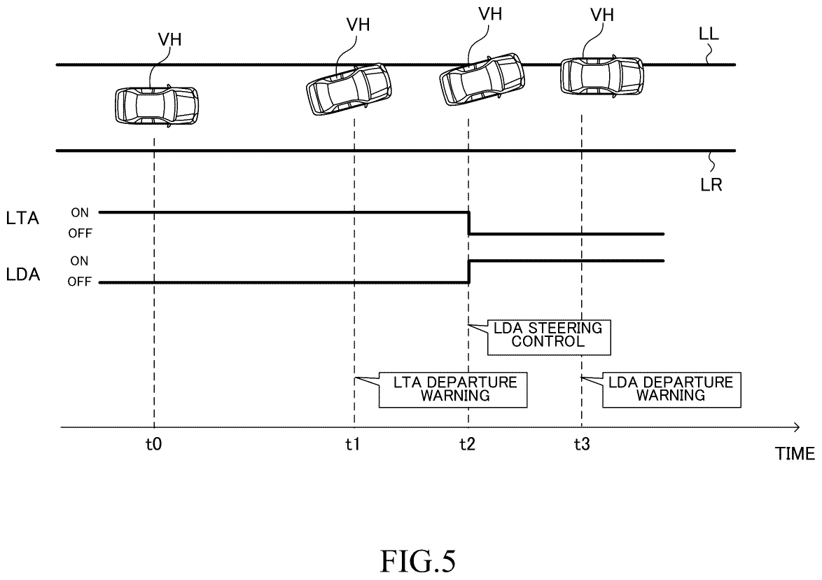

Specifically, as shown in FIG. 5, assume that during the execution of LTA control and while LDA control is active, the LTA warning execution condition is satisfied at time t1. In this case, an LTA deviation warning (audible alert and warning display) is issued at time t1. Subsequently, when the LDA steering initiation condition is satisfied at time t2, the LDA steering control is executed. Since the intervention of LDA steering control terminates the LTA control, the LTA deviation warning at time t1 becomes momentary. Furthermore, when the LDA warning execution condition is satisfied at time t3, an LDA deviation warning (audible alert, warning display, and vibration feedback) is issued. In other words, a lane departure warning via the LTA deviation warning is momentarily issued at time t1, and then, for the same lane departure, the LDA deviation warning is issued again at time t3, which may cause annoyance to the driver.

The LDA priority processing unit 130 effectively suppresses the driver's feeling of annoyance by preventing the LTA deviation warning and LDA deviation warning from being continuously issued. Specifically, during execution of LTA control, the LDA priority processing unit 130 executes LDA priority processing that gives precedence to activation of LDA control over issuance of the LTA deviation warning, thereby facilitating activation of the LDA control. The LDA priority processing may be realized, for example, by setting the LDA steering threshold T_{LDA_1}, which satisfies the LDA steering initiation condition, to be greater than the LTA warning threshold T_{LTA}, which satisfies the LTA warning execution condition. Alternatively, T_{LDA_1} may be set equal to T_{LTA}. Further, T_{LDA_1} may be set greater than the threshold used when LTA control is not being executed.

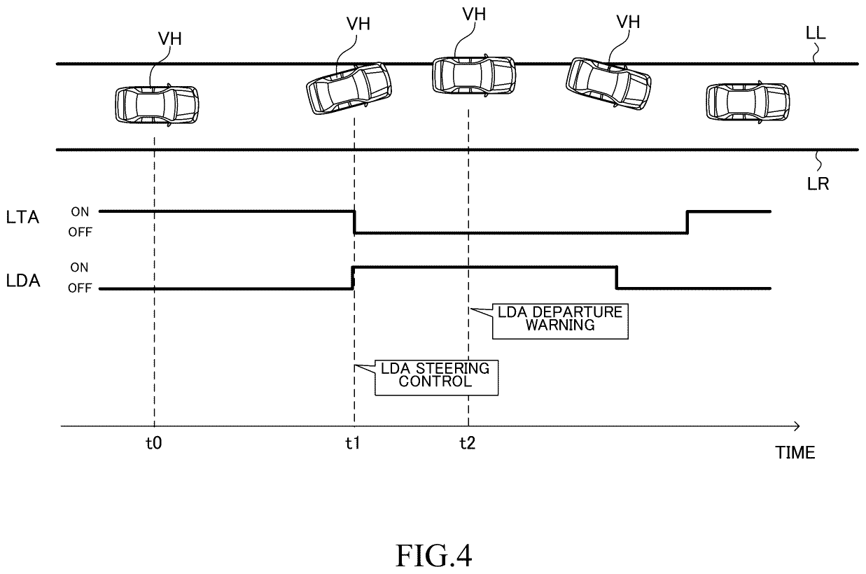

As described above, by executing the LDA priority processing during execution of LTA control, for example, as shown in FIG. 4, when the vehicle VH is about to deviate from the lane at time t1, the LDA steering control is initiated before the LTA deviation warning is issued. In other words, due to the early intervention of the LDA steering control, the LTA control is canceled, thereby suppressing the momentary issuance of the LTA deviation warning. As a result, even if the LDA deviation warning is issued at time t2 upon satisfaction of the LDA warning execution condition, it is possible to effectively prevent two types of deviation warnings from being issued in succession. Furthermore, since the LDA steering control is initiated early at time t1, which is prior to actual lane departure of the vehicle VH, it also becomes possible to effectively enhance the likelihood that the vehicle VH can avoid lane departure.

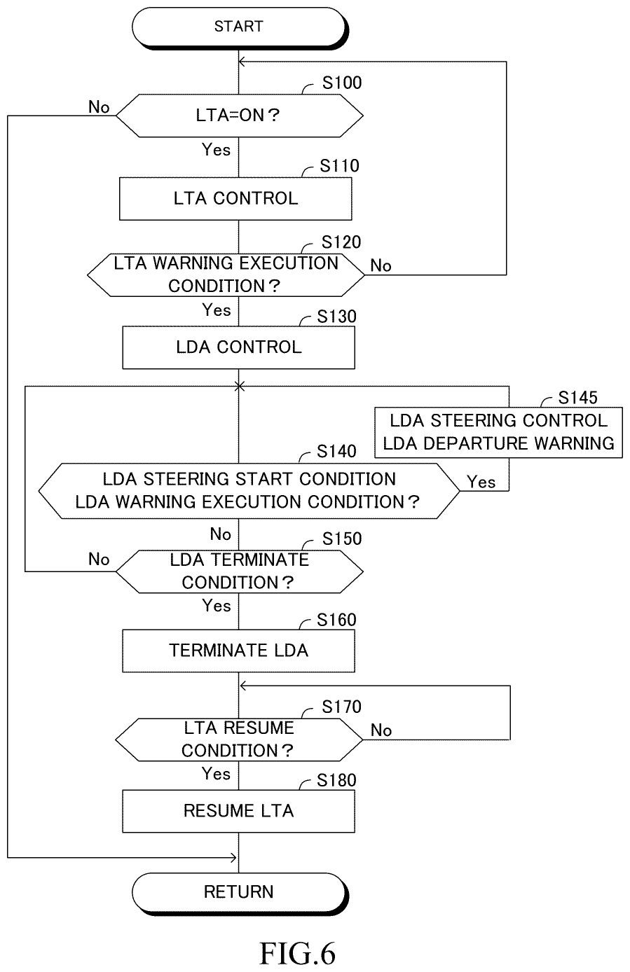

FIG. 6 is a flowchart for explaining the LDA priority processing routine executed by the CPU 11 of the ECU 10. This routine is initiated, for example, in response to the traveling of the vehicle VH.

In step S100, the ECU 10 determines whether the LTA activation switch 61 has been turned ON. If the LTA activation switch 61 is ON (Yes), the ECU 10 proceeds to the processing of step S110. On the other hand, if the LTA activation switch 61 is not ON (No), i.e., if the LTA activation switch 61 is OFF, the ECU 10 returns this routine.

In step S110, the ECU 10 executes the LTA control. Next, in step S120, the ECU 10 determines whether the LTA warning execution condition is satisfied. If the LTA warning execution condition is satisfied (Yes), the ECU 10 proceeds to the processing of step S130. On the other hand, if the LTA warning execution condition is not satisfied (No), the ECU 10 returns to the processing of step S100.

In step S130, the ECU 10 terminates the LTA control and executes the LDA control. Next, in step S140, the ECU 10 determines whether the LDA steering start condition and the LDA warning execution condition are satisfied. If the LDA steering start condition and the LDA warning execution condition are satisfied (Yes), the ECU 10 proceeds to step S145, executes the LDA steering control and the LDA departure warning, and then returns to the processing of step S140. On the other hand, if the LDA steering start condition and the LDA warning execution condition are not satisfied (No), the ECU 10 proceeds to step S150.

In step S150, the ECU 10 determines whether the LDA termination condition is satisfied. If the LDA termination condition is satisfied (Yes), the ECU 10 proceeds to step S160 and terminates the LDA control. On the other hand, if the LDA termination condition is not satisfied (No), the ECU 10 returns to the processing of step S140.

In step S170, the ECU 10 determines whether the LTA restart condition, under which the LTA control can be resumed, is satisfied. An example of the LTA restart condition is when the steering torque Tq, detected by the steering torque sensor 33, decreases to a predetermined value or less (i.e., in a case where the driver was applying steering input overlapping with the LDA steering control, and such input has subsided to a certain degree). If the LTA restart condition is satisfied (Yes), the ECU 10 proceeds to step S180. On the other hand, if the LTA restart condition is not satisfied (No), the ECU 10 returns to the processing of step S170.

In step S180, the ECU 10 resumes the LTA control. Thereafter, the ECU 10 returns this routine.

As described above, the lane departure warning device, lane departure warning method, and program according to the present embodiment have been explained. However, the present disclosure is not limited to the above-described embodiment, and various modifications may be made without departing from the scope and spirit of the present disclosure.

For example, in the above embodiment, the LDA priority processing has been described as being performed by advancing the activation timing of the LDA steering control. However, it is also possible to configure the system to advance not only the activation timing of the LDA steering control but also the activation timing of the LDA departure warning. Furthermore, the technology of the present disclosure can also be applied to autonomous vehicles that perform part or all of the driving operations automatically.

What is claimed is:

1. A lane departure warning device configured to execute a warning when a vehicle departs or is likely to depart from a traveling lane during driving, comprising:
a first alert unit configured to determines whether the vehicle is likely to depart from the traveling lane during execution of a lane keeping control to keep the vehicle within the traveling lane, and when determines that lane departure is likely, executes a first departure warning;
a second alert unit configured to determines whether the vehicle is likely to depart from the traveling lane during travel of the vehicle, and when determined that lane departure is likely, performs a steering control to suppress the lane departure of the vehicle and executes a second departure warning; and
a priority processing unit configured to prioritizes at least one of the steering control or the second departure warning by the second alert unit over the execution of the first departure warning by the first alert unit during execution of the lane keeping control.

2. The lane departure warning device according to claim 1,
wherein the priority processing is executed by advancing the timing of execution of at least one of the steering control or the second departure warning by the second warning unit relative to the timing of execution of the first departure warning by the first warning unit.

3. The lane departure warning device according to claim 1,
wherein the priority processing is executed by suspending the first departure warning by the first warning unit and causing the second warning unit to perform at least one of the steering control or the second departure warning, when it is determined by the first warning unit or the second warning unit that the vehicle is likely to depart from the lane.

4. A lane departure warning method for executing a warning when a vehicle departs or is likely to depart from a traveling lane in which the vehicle is traveling,
wherein the method comprising:
determining whether the vehicle is likely to depart from the traveling lane during execution of a lane keeping control that maintains the vehicle within the traveling lane, and executing a first departure warning when it is determined that the vehicle is likely to depart;
determining, while the vehicle is traveling, whether the vehicle is likely to depart from the traveling lane, and executing a steering control that suppresses departure of the vehicle from the traveling lane and a second departure warning when it is determined that the vehicle is likely to depart; and
executing priority processing during the execution of the lane keeping control, wherein the priority processing gives priority to execution of at least one of the steering control or the second departure warning over execution of the first departure warning.

5. A program that causes a computer of a lane departure warning device, which executes a warning when a vehicle departs or is likely to depart from a traveling lane in which the vehicle is traveling, to execute:
a first warning process that determines, during execution of a lane keeping control for maintaining the vehicle within the traveling lane, whether the vehicle is likely to depart from the traveling lane, and executes a first departure warning when it is determined that the vehicle is likely to depart;
a second warning process that determines, while the vehicle is traveling, whether the vehicle is likely to depart from the traveling lane, and executes a steering control to suppress departure of the vehicle from the traveling lane and a second departure warning when it is determined that the vehicle is likely to depart; and
a priority process that, during execution of the lane keeping control, prioritizes execution of at least one of the steering control or the second departure warning by the second warning process over execution of the first departure warning by the first warning process.
